(19) United States
(12) Patent Application Publication
(10) Pub. No.: US 2013/0342696 A1
(43) Pub. Date: Dec. 26, 2013

(54) MONITORING THROUGH A TRANSPARENT DISPLAY OF A PORTABLE DEVICE

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/568,699

(22) Filed: Aug. 7, 2012

Related U.S. Application Data
(63) Continuation-in-part of application No. 13/531,715, filed on Jun. 25, 2012.

(51) Int. Cl. H04N 7/18; G09G 5/00

(52) U.S. Cl. 348/148; 345/633; 348/E07.085

(57) ABSTRACT

Traffic obstacles or other objectives in front of a person is monitored by using a monitoring system including a portable device, a camera unit, and a control unit. The portable device can be a helmet or glasses, which includes a display unit with a transparent display allowing a user to view a scene through the transparent display. The camera unit produces scene images of the scene. The control unit determines objective(s) according to the scene images, and transmits objective data corresponding to the objective(s) to the display unit. The transparent display of the display unit displays objective information indicating virtual image(s) of the objective(s) seen through the transparent display according to the objective data.

### CROSS-REFERENCE OF RELATED APPLICATIONS

This application is a continuation-in-part of U.S. application Ser. No. 13/531,715 filed Jun. 25, 2012 by Cai et al., the entire disclosure of which is incorporated herein by reference.

### BACKGROUND

1. Technical Field

The present disclosure relates to a monitoring system, and particularly to a monitoring system displaying information as to objectives such as traffic obstacles through a transparent display of a portable device.

2. Description of Related Art

Traffic accidents are often caused by driver inattention. For an emergency service vehicle such as, fire truck, ambulance, or police car, traffic accidents are liable to happen when the emergency service vehicle is moving at a high speed when going to the location of the emergency. Although alarms such as sirens can be used, it is still difficult for pedestrians or the driver of other vehicles near to the emergency service vehicle to quickly take evasive action. In addition, traffic accidents are also liable to happen during the night because of reduced vision.

Therefore, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a monitoring system of the present disclosure.

FIG. 2 is a schematic diagram of a virtual image of the objective seen through the transparent display shown in FIG. 1.

FIG. 3 is a schematic diagram of displaying objective information through the transparent display shown in FIG. 1.

FIG. 4 is a block diagram of another embodiment of a monitoring system of the present disclosure.

FIG. 5 is a flowchart of an embodiment of a monitoring method implemented through the monitoring system shown in FIG. 1.

### DETAILED DESCRIPTION

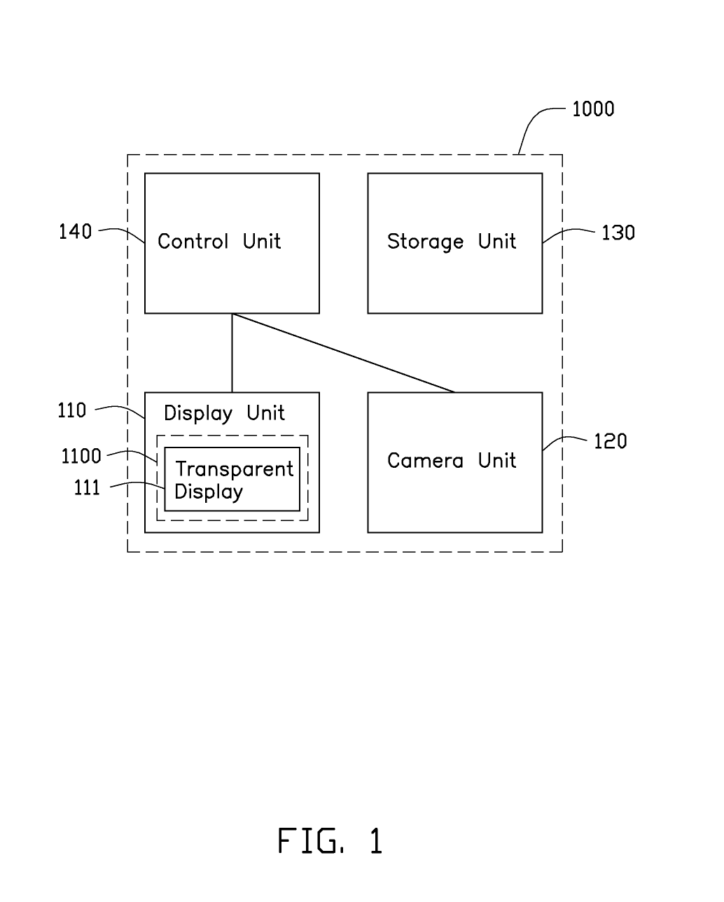

FIG. 1 is a block diagram of an embodiment of a monitoring system of the present disclosure. The monitoring system is applied to a portable device 1000. In the illustrated embodiment, the portable device 1000 is a helmet. In other embodiments, the portable device 1000 can be other types of portable devices such as eyeglasses. The monitoring system includes a display unit 110, a camera unit 120, a storage unit 130, and a control unit 140. The display unit 110, the camera unit 120, the storage unit 130, and the control unit 140 are disposed on the portable device 1000.

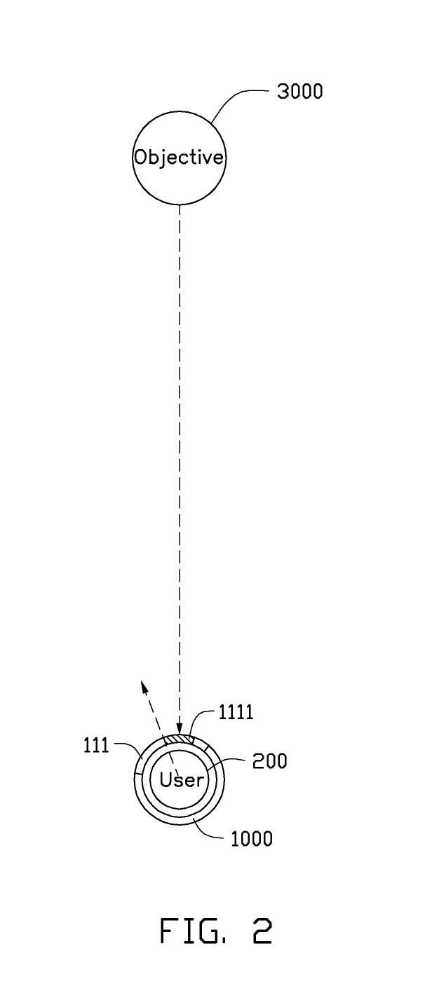

The display unit 110 includes a transparent display 111. The transparent display 111 is a transparent portion of the display unit 110 such as a display panel which allows a user 2000 (see FIG. 2) of the portable device 1000, who is wearing the portable device 1000 to view a scene through the transparent portion, while information such as graphs or characters can be shown on the transparent portion. In the illustrated embodiment, the transparent display 111 is a transparent active-matrix organic light-emitting diode (AMOLED) display disposed on a front portion 1100 of the portable device 1000 to be used as a visor. The transparent display 111 has an inflexible structure, such that the transparent display 111 can be fixed on a frame of the front portion 1100. In other embodiments, the transparent display 111 can have a flexible structure, such that the transparent display 111 can be stuck on a glass or a plastic fixed on the front portion 1100. In addition, the transparent display 111 can be another type of transparent/translucent display such as a transparent liquid crystal display (LCD) display. Furthermore, the display unit 110 can be a display device with the transparent display 111 such as a glass and a projector capable of projecting on the transparent display 111.

The camera unit 120 produces scene images Gs (not shown) of the scene which can be viewed through the transparent display 111 of the portable device 1000. In the illustrated embodiment, the camera unit 120 includes camera(s) producing the scene images Gs, such as still photographs or videos, wherein the camera unit 120 has night-vision functionality such that the scene images Gs can be produced in darkness and in a lighted environment. In other embodiments, the camera unit 120 can include a plurality of cameras producing the scene images Gs from different directions, thereby avoiding dead spots or blind spots.

The storage unit 130 is a device such as a random access memory, a non-volatile memory, or a hard disk drive for storing and retrieving digital information, which stores sample objective data Ds (not shown) including sample objective figures and objective conditions. Herein, “objective” when used as a noun describes an object or a movement or a state (objective conditions) on or of the road which is significant to a driver, “objective data Do” (not shown) may mean statements or warnings relevant to each objective, “sample objective data Ds” is the generic name of a pre-recorded collection of all such data. These definitions may be specifically extended hereafter. In the illustrated embodiment, the sample objective figures are figures of possible traffic obstacles such as vehicles, humans, animals, huge objects, suspicious objects, or potholes in the road. The objective conditions are the possible traffic obstacles which may cause problems to the portable device 1000. The possible traffic obstacle can correspond to one or more objective conditions when, for instance, the possible traffic obstacle is located in the middle of a road while the user 2000 is approaching, or the possible traffic obstacle is itself approaching the user 2000 at high speed. In other embodiments, the sample objective figures can be figures of other types of possible objectives, for example, particular and favorite objects of the user 2000.

The control unit 140 receives the scene images Gs, and determines objective(s) 3000 (see FIG. 2) according to the scene images Gs by, for instance, using the sample objective data Ds to analyze the scene images Gs by way of comparison. In the illustrated embodiment, the objective 3000 is a traffic obstacle. The control unit 140 compares the scene images Gs with the sample objective figures in the sample objective data Ds to recognize the possible traffic obstacles, and compares the condition of the possible traffic obstacles with the objective conditions in the sample objective data Ds. The control unit 140 then transmits the objective data Do corresponding to the objective 3000 to the display unit 110. For instance, when a possible traffic obstacle is in the middle of a road as determined by the control unit 140 while the user 2000 is approaching, the control unit 140 transmits the objective data Do representing the information of the possible traffic obstacle to the display unit 110. In other embodiments, the objective 3000 can be another type of object. The control unit 140 produces the objective data Do to correspond to the objective 3000 while the camera unit 120 can track the objective 3000 when the objective 3000 is moving.

In the illustrated embodiment, the objective data Do includes objective information data Di (not shown) and objective position data Dp (not shown). The control unit 140 produces the objective information data Di including information concerning the objective 3000 such as the name, the type, and/or the description of the objective 3000 according to, for example, the sample objective figure and the objective condition in the sample objective data Ds which correspond to the objective 3000. For instance, when the control unit 140 determines the objective 3000 to be a possible traffic obstacle in the middle of a road according to the sample objective figure and the objective condition corresponding to the objective 3000, the objective information data Di can include the description about the possible traffic obstacle. The pre-stored information concerning the objective 3000 can be in the storage unit 130, or be pre-stored in, and received from, a server connected to the monitoring system through a long distance wireless network, wherein the information can be, for example, an augmented reality information received from the server which is an augmented reality server.

FIG. 2 is a schematic diagram of a virtual image 1111 of the objective 3000 seen through the transparent display 111 shown in FIG. 1. The control unit 140 produces the objective position data Dp including the position of the virtual image 1111 of the objective 3000 seen through the transparent display 111, wherein the virtual image 1111 is a virtual image viewed from a particular position P (not shown) of the portable device 1000 through the transparent display 111. In the illustrated embodiment, the particular position P is predetermined, which can be, for example, a position where the eyes of the user 2000 are focused. The control unit 40 determines the position of the virtual image 1111 on the transparent display 111 according to the position of the figure of the objective 3000 in the scene images Gs and the position of the particular position P, and produces the objective position data Dp representing the position(s) of the transparent display 11 adjacent to the position of the virtual image 1111 on the transparent display 11. In other embodiments, the particular position P can be manually configured.

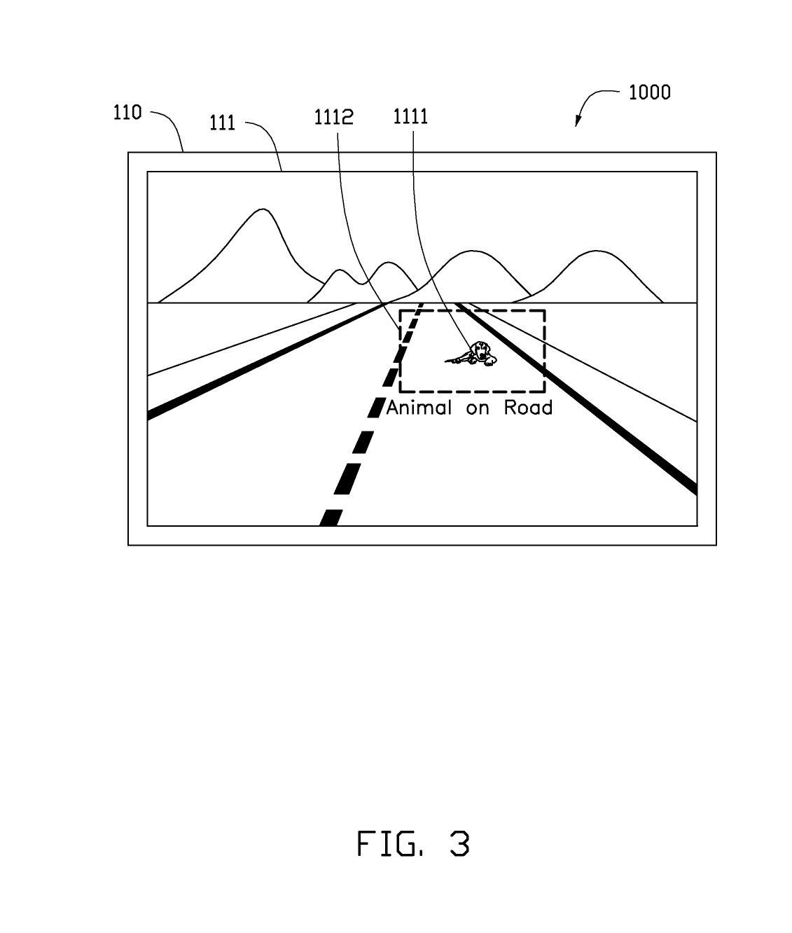

The display unit 110 receives the objective data Do from the control unit 140. Objective information 1112 (see FIG. 3) is displayed through the transparent display 111 according to the objective information data Di in the objective data Do which includes the information concerning the objective 3000 and the objective position data Dp in the objective data Do which corresponds to the position(s) of the transparent display 111 corresponding to the position of the virtual image 1111, thereby giving a description to accompany the virtual image 1111. FIG. 3 is a schematic diagram of displaying the objective information 1112 through the transparent display 111 shown in FIG. 1. The objective information 1112 representing the information concerning the objective 3000 is displayed on a position of the transparent display 111 which is adjacent to the position of the virtual image 1111 on the transparent display 11, thereby describing the virtual image 1111 to warn the user 2000 visually of the appearance of the objective 3000. The objective information 1112 may include, for example, a graph encircling or pointing to the virtual image 1111 and/or characters representing the information concerning the objective 3000. Since the control unit 140 produces the objective data Do corresponding to any movement of the objective 3000, the position of the objective information 1112 on the transparent display 111 also changes with the movement of the objective 3000.

In addition to the camera unit 120, other types of sensors can be used to produce sample objective data Ds, such that the control unit 140 can identity the objective 3000 to the user 2000 according to data from the other sensors and the scene images Gs produced by the camera unit 120. For instance, microphones can be used to produce environmental voice data, such that the control unit 140 can identify and describe the objective 3000 audibly as well as by the scene images Gs. In addition to the display unit 110 which displays the objective information 1112, other types of device can be used to provide objective information. For instance, a loudspeaker can be used to receive the objective data Do from the control unit 140 and produce audible warning(s) according to the objective data Do, thereby warning the user 2000 of the appearance of the objective 3000.

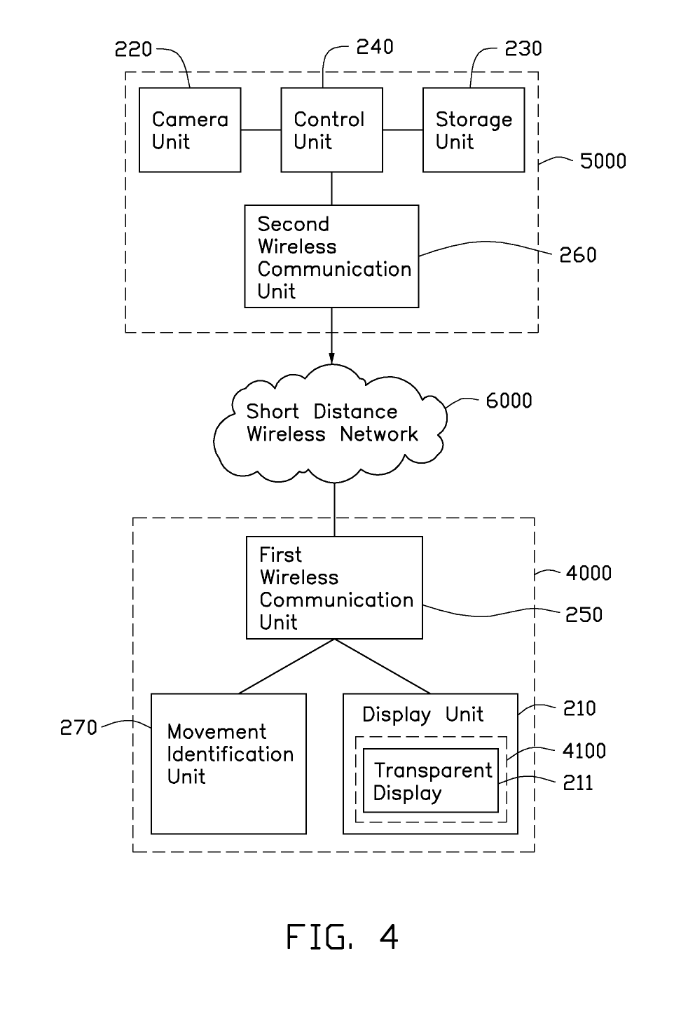

FIG. 4 is a block diagram of another embodiment of a monitoring system of the present disclosure. The monitoring system includes a display unit 210, a camera unit 220, a storage unit 230, a control unit 240, a first wireless communication unit 250, a second wireless communication unit 260, and a movement identification unit 270. In the illustrated embodiment, the display unit 210, the first wireless communication unit 250, and the movement identification unit 270 are disposed on a portable device 4000. The portable device 4000 can be eyeglasses. The camera unit 220, the storage unit 230, the control unit 240, and the second wireless communication unit 260 are disposed on a vehicle 5000 such as an automobile, a ship or an airplane. In other embodiments, the portable device 4000 can be other types of portable device such as helmets, and the storage unit 230 and/or the control unit 240 can be disposed on the portable device 4000.

In the illustrated embodiment, the display unit 210 includes a transparent display 211. The transparent display 211 is a transparent AMOLED display disposed on a frame of a glass portion 4100 of the portable device 4000. The camera unit 220 produces the scene images Gs of the scene which can be viewed through the transparent display 211 of the portable device 4000. The storage unit 430 stores the sample objective data Ds including sample objective figures and objective conditions. The control unit 240 receives the scene images Gs and determines the objective(s) 3000 according to the scene images Gs by using the sample objective data Ds to analyze the scene images Gs by way of comparison. The first wireless communication unit 250 communicates with the second wireless communication unit of the vehicle 5000 through a short distance wireless network 6000 implemented according to BLUETOOTH telecommunication standard or other telecommunication standards such as near field communication (NFC).

The movement identification unit 270 is disposed on the portable device 4000 to determine a movement (for example, up, down, left, or right movement) of the portable device 4000. The movement identification unit 270 determines the movement according to the variation of a direction and an angle of the portable device 4000. In the illustrated embodiment, the movement identification unit 270 includes a direction identification unit determining a direction of the portable device 4000 and an angle identification unit determining an angle of the portable device 4000, wherein the direction identification unit may include an electronic compass and the angle identification unit may include a gravity sensor. The camera unit 220 moves according to the movement of the portable device 4000, thereby producing the scene images Gs corresponding to the vision angle of the user 2000 through the transparent display 111 of the portable device 1000.

A relative location compensation unit can be used to determine a difference between the relative location (for example, the relative distance and/or the relative direction) between the portable device 4000 and the objective 3000 as well as the relative location between the camera unit 20 and the objective 3000. The control unit 40 can compensate for the difference by, for instance, enabling the camera unit 20 to zoom in or re-orientate according to the difference, or by enabling the control unit 40 to consider the difference when determining the position of the virtual image 1111 on the transparent display 11, thereby eliminating any inaccuracy between the display and the factual situation which are caused by the difference. The location of the portable device 4000 can be manually configured, or automatically detected by, for instance, using a detection device. In this case, the control unit 40 can compensate for a difference between the relative location between the user 2000 and the objective 3000 as well as the relative location between the camera unit 20 and the objective 3000 which has been determined by a relative location compensation unit.

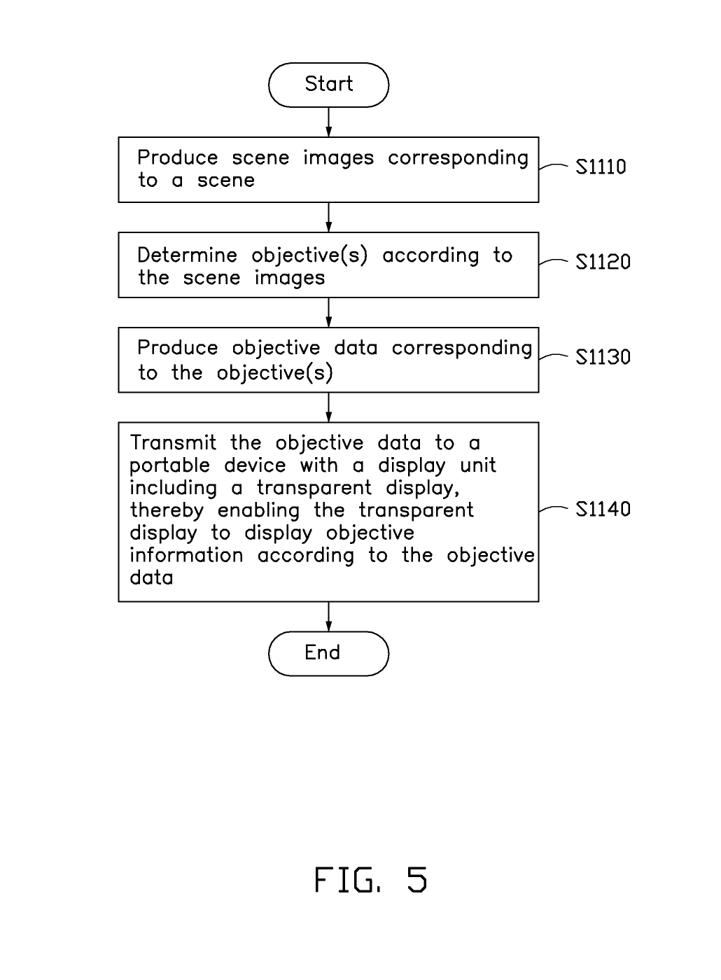

FIG. 5 is a flowchart of an embodiment of a monitoring method implemented through the monitoring system shown in FIG. 1. The monitoring method of the present disclosure follows. Depending on the embodiment, additional steps may be added, others removed, and the ordering of the steps may be changed.

In step S1110, the scene images Gs corresponding to a scene are produced. The objective 3000 is tracked when the objective 3000 moves. As the objective 3000 moves, the scene images Gs are produced corresponding to the movement of the objectives 3000. In the illustrated embodiment, camera(s) with night-vision functionality are used to produce the scene images Gs. In addition, step S1110 is performed by the camera unit 120 disposed on the portable device 1000. In other embodiments, step S1110 can be performed by the camera unit 220 disposed on the vehicle 5000. The scene images Gs corresponding to the scene can be produced according to a movement of the portable device 4000, wherein the movement of the portable device 4000 can be determined according to the variation of a direction and an angle of the portable device 4000. Correspondingly, the scene images Gs corresponding to the scene can be produced according to the movement of the portable device 4000.

In step S1120, the objective 3000 is determined according to the scene images Gs. The objective 3000 can be determined according to the scene images Gs by, for instance, using the sample objective data Ds including the sample objective figures and the objective conditions to analyze the scene images Gs. In the illustrated embodiment, the objective 3000 is determined by comparing the scene images Gs with the sample objective figures to recognize possible traffic obstacles, and the condition of the possible traffic obstacles with the objective conditions are compared.

In step S1130, the objective data Do corresponding to the objective 3000 is produced. The objective data Do is produced to correspond to the movement of the objective 3000 when the objective 3000 moves. In the illustrated embodiment, the objective data Do includes the objective information data Di and the objective position data Dp. The objective information data Di includes the information concerning the objective 3000. The objective position data Dp corresponds to the virtual image 1111 of the objective 3000 seen through the transparent display 111, wherein the virtual image 1111 is viewed from a particular position P.

In step S1140, the objective data Do is transmitted to the portable device 1000 with the display unit 110. The display unit 110 includes the transparent display 111 allowing the user 2000 to view the scene through the transparent display 111, thereby enabling the transparent display 111 to display the objective information 1112 according to the objective data Do, wherein the objective information 1112 indicates the virtual image 1111 of the objective 3000 seen through the transparent display 111 by accompanying, labeling, or pointing to the virtual image 1111. In the illustrated embodiment, the transparent display 111 displays the objective information 1112 according to the objective information data Di in the objective data Do, while the objective information 1112 is displayed at position(s) of the transparent display 111 which corresponds to the objective position data Dp in the objective data Do to accompany the virtual image 1111.

The monitoring system is capable of displaying information as to objectives such as traffic obstacles through a transparent display on a portable device, thereby automatically informing a user about the appearance of the objectives. Camera(s) with night-vision functionality can be used to produce images of the objectives, thereby recognizing the objectives both in darkness and in a lighted environment.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A monitoring system, comprising:
a portable device comprising a display unit, wherein the display unit comprises a transparent display allowing a user to view a scene through the transparent display; wherein the transparent display displays one or more objective information indicating one or more virtual images of one or more objectives in the scene seen through the transparent display according to one or more objective data;
one or more camera units producing one or more scene images corresponding to the scene; and
a control unit, wherein the control unit determines the one or more objectives according to the one or more scene images and transmits the one or more objective data corresponding to the one or more objectives to the display unit.

2. The monitoring system of claim 1, wherein each of the one or more objectives is a traffic obstacle.

3. The monitoring system of claim 1, wherein the portable device comprises one of a helmet and eyeglasses.

4. The monitoring system of claim 1, wherein the one or more camera units are disposed on the portable device.

5. The monitoring system of claim 1, further comprising a movement identification unit disposed on the portable device to determine a movement of the portable device, wherein the one or more camera units are disposed on a vehicle, the one or more camera units move according to the movement of the portable device.

6. The monitoring system of claim 5, wherein the movement identification unit comprises a direction identification unit and an angle identification unit, the direction identification unit determines a direction of the portable device, the angle identification unit determines an angle of the portable device, the movement identification unit determines the movement of the portable device according to the variation of the direction and the angle of the portable device.

7. The monitoring system of claim 5, wherein the control unit is disposed on the vehicle, the portable device includes a wireless communication unit, the portable device communicates with the vehicle through the wireless communication unit.

8. The monitoring system of claim 1, wherein the transparent display comprises at least one of a transparent active-matrix organic light-emitting diode (AMOLED) display and a transparent liquid crystal display (LCD) display.

9. The monitoring system of claim 1, further comprising a storage unit storing one or more sample objective data, wherein the control unit determines the one or more objectives by analyzing the one or more scene images according to the one or more sample objective data.

10. The monitoring system of claim 9, wherein the one or more sample objective data comprises one or more objective conditions, the control unit analyzes the one or more scene images by comparing the condition of one or more possible objectives recognized from the one or more scene images with the one or more objective conditions.

11. The monitoring system of claim 1, wherein the one or more camera units has night-vision functionality.

12. The monitoring system of claim 1, wherein the one or more camera units track the one or more objectives when the one or more objectives move, the control unit produces the one or more objective data to correspond to the movement of the one or more objectives.

13. A monitoring method for a portable device with a display unit comprising a transparent display allowing a user to view a scene through the transparent display, the method comprising:
producing one or more scene images corresponding to the scene;
determining one or more objectives according to the one or more scene images;
producing one or more objective data corresponding to the one or more objectives; and
transmitting the one or more objective data to the portable device with the display unit comprising the transparent display allowing the user to view the scene through the transparent display, to enable the transparent display to display one or more objective information indicating one or more virtual images of the one or more objectives in the scene seen through the transparent display according to the one or more objective data.

14. The monitoring method of claim 13, further comprising:
determining a movement of the portable device;
wherein the step of producing the one or more scene images comprises:
producing the one or more scene images corresponding to the scene according to the movement of the portable device.

15. The monitoring method of claim 14, wherein the step of determining the movement of the portable device comprises:
determining a direction of the portable device; and
determining an angle of the portable device;
the step of producing the one or more scene images comprises:
determining the movement of the portable device according to the variation of the direction and the angle of the portable device; and
producing the one or more scene images corresponding to the scene according to the movement of the portable device.

16. The monitoring method of claim 13, wherein the step of determining the one or more objectives comprises analyzing the one or more scene images according to one or more sample objective data to determine the one or more objectives.

17. The monitoring method of claim 16, wherein the one or more sample objective data comprises one or more objective conditions, the step of analyzing the one or more scene images comprises comparing the condition of one or more possible objectives recognized from the one or more scene images with the one or more objective conditions to determine the one or more objectives.

18. The monitoring method of claim 13, wherein the step of producing the one or more scene images comprises using one or more cameras to produce the one or more scene images corresponding to the scene; wherein at least a portion of the one or more cameras have night-vision functionality.

19. The monitoring method of claim 13, further comprising tracing the one or more objectives when the one or more objectives move, wherein the step of producing the one or more scene images comprises producing the one or more scene images corresponding to the scene to correspond to the movement of the one or more objectives.
